(19) United States
(12) Patent Application Publication
(10) Pub. No.: US 2002/0003810 A1
(43) Pub. Date: Jan. 10, 2002

(54) Template for creating cells in cell relay networks

(76) Inventor: Stephen Guy Routliffe, Kanata (CA)

Correspondence Address: MARKS & CLERK, Station B, P.O. Box 957, Ottawa, ON, K1P 5S7, CA

(21) Appl. No.: 09/767,150

(22) Filed: Jan. 23, 2001

(30) Foreign Application Priority Data
Jan. 25, 2000 (GB) 0001534.7

(51) Int. Cl. H04J 3/24

(52) U.S. Cl. 370/473

(57) ABSTRACT

ATM cells for use in a cell relay network are assembled by creating a template data structure representing the structure of a cell to be assembled, storing the template data structure in memory, and creating cells by retrieving the template data structures and inserting variable information therein.

### BACKGROUND OF THE INVENTION

1. Field of the Invention

This invention relates to cell relay networks, such as ATM (Asynchronous Transfer Mode) networks, and more particularly to a method and device for constructing cells for transmission over such a network.

2. Description of the Prior Art

In a cell relay network, such as ATM, the data is assembled in to fixed size cells which are transferred over the network in accordance with information stored in the cell header. In case of ATM cells are 53 bytes in length with five bytes reserved for the header.

The cells are assembled by the ATM Adaptation Layer (AAL). Various layers, numbered from 1 to 5, offer different types of service. For example, AAL 1 relates to a service that offers constant bit rate traffic, such as voice or video traffic. In the prior art, cells must be custom assembled before being passed to a UTOPIA interface for connection to the physical layer. However, this process can be unnecessarily slow because much of the information contained in the headers does not change from cell to cell.

### SUMMARY OF THE INVENTION

The invention provides a method of assembling cells using predefined templates with variable fields to improve the efficiency of the reassembly process.

According to the present invention there is provided a method of assembling cells for use in a cell relay network, comprising the steps of creating a template data structure representing the structure of a cell to be assembled, storing said template data structure in memory, and creating cells by retrieving said template data structures and inserting variable information therein.

The cell template data structures (CTDS) are typically used in an ATM Adaptation Layer type 1 (AAL1) to produce ATM cells. CTDS allow the functions of an AAL type1, as defined in of ITU-T COM 13-R 51-E AAL, to be implemented. CTDS can also be used in implementations which support Circuit Emulation Service (CES) as described in ATM Forum Specification af-vtoa-0078.00 and Dynamic Structure Sizing (DSS) as defined in ATM Forum Specification af-vtoa-0085.00.

A CTDS contains information which is required to construct cells for a virtual circuit (VC). The CTDS typically resides in a memory device such as RAM or registers and is preferably be created by software running on a central processing unit (CPU). The Segmentation portion of the SAR (Segmentation and reassembly) sublayer of an AAL1 Layer can use the information contained in the CTDS to produce cells for a VC. A separate CTDS is used for each VC being supported by the SAR.

CTDSs may be used to support CBR Cells, such as UDT (Unstructured Data Transfer) Cells, SDT (Structured Data Transfer) Cells with and without CES, and DSS (Dynamic Structure Sizing) Cells with and without CES.

The cell templates are normally located in memory. A pointer table is used for this purpose. There is a separate pointer for each VC and, possibly, a separate pointer table for each port.

In a preferred implementation, the UDT Cell Template structure consists of 5 fields each of which are 16 bits wide. Fields 1-3 Contain the cell header and remain static after being written by the CPU. Field 0 holds the sequence number of the next cell and SRTS information. The segmentation system modifies this field after each cell is produced.

In the SDT Cell Template, fields 0-6 may be used to determine when to produce the cell, control the number of channels being sent in the VC, hold SRTS data, determine when to produce a pointer cell, determine the value of the offset field of a pointer cell, calculate the AAL1 Header byte, determine when to place CAS values in the cell, and determine the location of the next TDM/CAS value to be placed in the cell

Fields 7-9 contain cell header information

The remaining fields of the control structure contain pointers to circular buffers (1 pointer for every channel in the VC) which contain TDM data. The pointers are read in a round robin fashion and are used to control which channels are to be placed into the cell payload.

In one preferred embodiment of the invention, the SDT DBCES (Structured Data Cell, Dynamic Bandwidth Circuit Emulation Service) template is typically divided into 3 major regions. The first (fields 0 to 5) contains information such as the cell header which does not change when the multiframe structure is re-sized.

The Alpha and Beta regions of the structure contain the information which changes during a multiframe resize. If the Segmentation process is using the Alpha region to construct cells then the CPU may modify the contents of the Beta region and vice versa. The cr (current region) bit of field 0 is used by the CPU to determine which region may be modified.

After the CPU has finished writing information to a region it will program the nr (next region) bit of field 0. The cr bit will be set equal to the nr bit by the Segmentation process at the next structure boundary after the next valid pointer and the new multiframe structure will then be sent.

### BRIEF DESCRIPTION OF THE DRAWINGS

The invention will now be described in more detail, by way of example, only with reference to the accompanying drawings, in which:

FIG. 1 is a system level view of a TXSAR module;

FIG. 2 is a block diagram of a TxSAR block and internal memory;

FIG. 3 shows a data cell control structure;

FIG. 4 shows the TxSAR control structure;

FIG. 5 shows the control structure pointer table for port X;

FIG. 6 shows the TxSAR control structure for SDT non DBCES mode;

FIG. 7 shows how the read_pointer is used to access circular buffers; and

FIG. 8 shows the DBCES control structure.

### DETAILED DESCRIPTION OF THE PREFERRED EMBODIMENTS

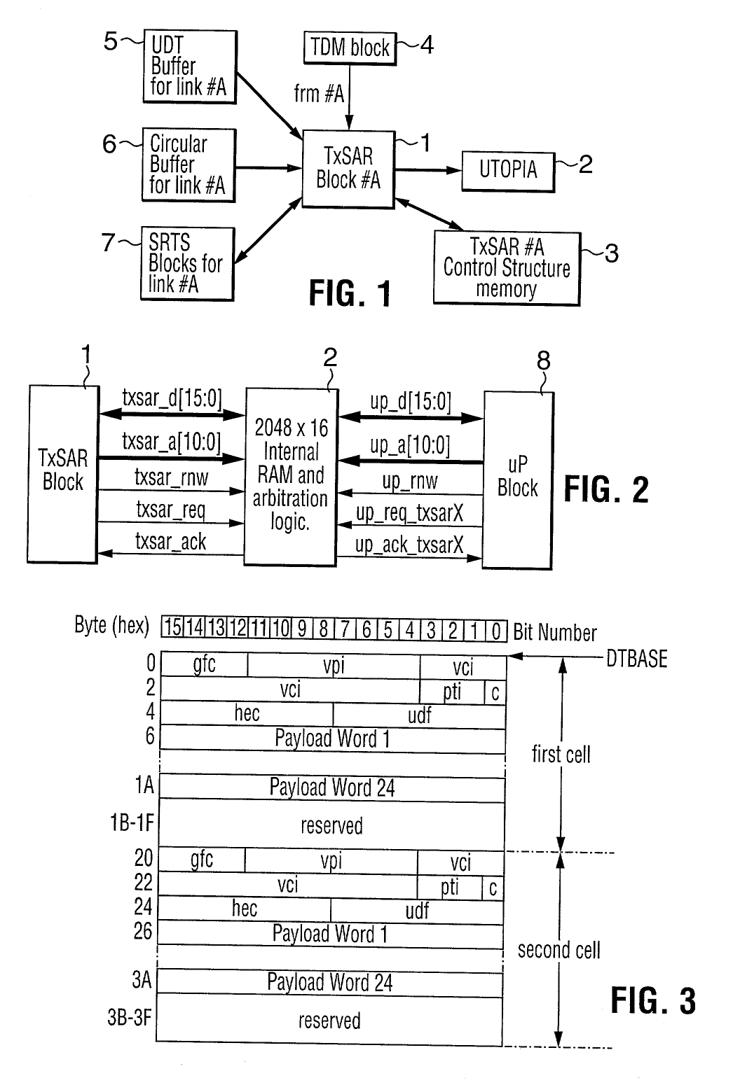

Referring now to FIG. 1, a TxSARs (Transmit Segmentation and Reassembly module) includes a TxSAR block 1, which outputs ATM cells to a UTOPIA interface 2 and is connected over a bidirectional link to a control structure memory 3. The TxSAR block 1 receives data from UDT buffer unit 5, circular buffer unit 6, and SRTS unit 7.

The memory 3, as shown in FIG. 2, is a 1056×16 block of internal RAM memory, which in turn is connected to a microprocessor block 8. The memory 3 contains a control structure for each VCC of the TDM port and is used in the cell assembly process. The format of the control structure depends on the mode of operation (UDT, SDT (non DBCES), SDT (DBCES)). The control structures are discussed below.

The data TX_SAR control structure is shown in FIG. 3. The Base Address of the TxDataCell FIFO in external memory is selected in the Data TX_SAR configuration register (1038). This register is also used to select the size of the cell fifo. Cells must begin on 64 byte boundaries as illustrated in FIG. 3.

Cell transmission begins when the write pointer is set to the top of the FIFO and the Data TX_SAR is enabled via a TDSEN bit in register 103E. The cells in the FIFO will be sent in order starting with the lowest memory address. After each cell is produced the Data TX_SAR increments a read_pointer and cell transmission will cease when the read pointer is equal to the write pointer. If the write pointer is set to be higher then the size of the fifo the Data TX_SAR will continuously send the contents of the FIFO.

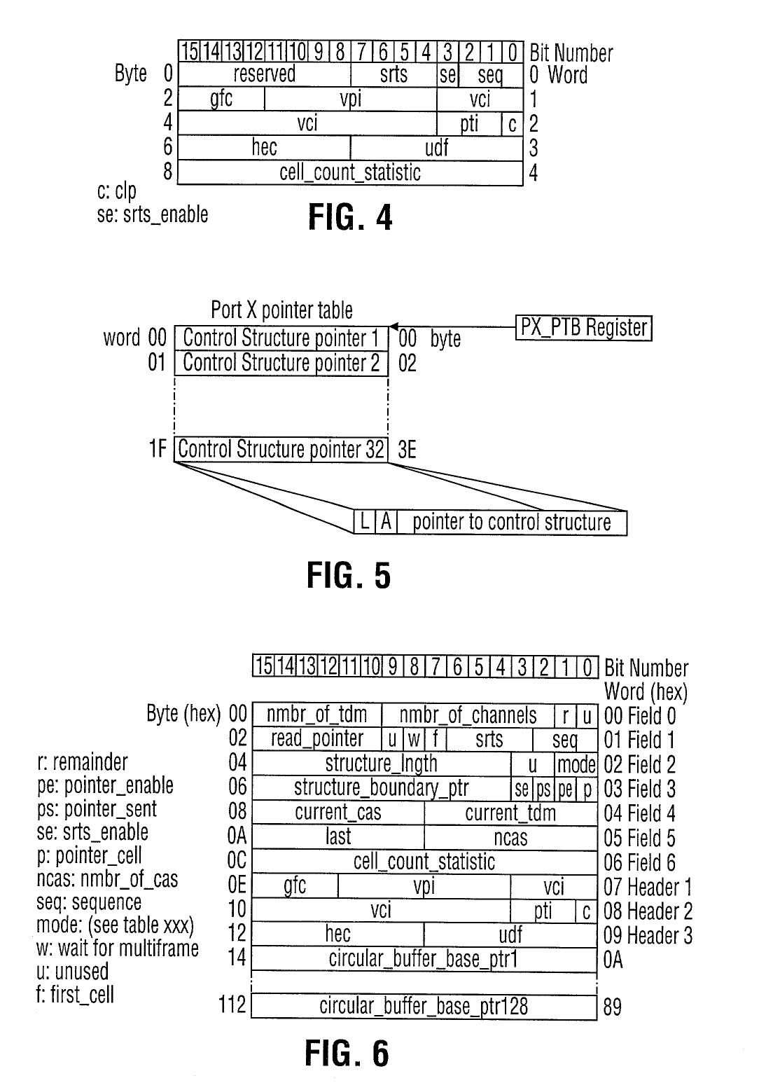

The same memory is used for both SDT and UDT. In the UDT mode, however, only the lower five locations of the memory are used. FIG. 4 shows the format of the control structure for one of 28 TDM ports feeding the TX_SAR.

Each of the fields of the control structure are described in detail as follows:

Field 0

reserved (bits 15:8):

These bits are reserved for future revisions of the chip and are initialized to 0

srts (bits 7:4):

If the srts_enable (se) bit of the control structure is set to one then the TxSAR will read an srts nibble from the Clock Management block at the beginning of each cell sequence (sequence=b#000). This value will be stored in the srts bits. In cells with odd sequence numbers the most significant srts bit will be placed into the csi bit of the SAR-PDU header. The SRTS value will then be shifted left and written back to the srts bits. In this way a complete SRTS nibble will be sent in each 8 cell sequence. srts enable (bit 3):

The srts_enable (se) bit is used to indicate that the VCC is carrying SRTS data. When high the TxSAR will place SRTS data into the csi bit, of the SAR-PDU header, in cells with odd sequence values. When low the csi bit will always be set to zero.

sequence(bits 2:0):

These bits hold the sequence number of the next cell to be transmitted. The sequence bits should be initialized to b#000 by the cpu.

Field 1

gfc (bits 15:12):

The gfc (Generic Flow Control) value is placed in the gfc field of the cell header in a UNI cell. If the associated cell is NNI these bits form the four most significant bits of the vpi.

vpi (bits 11:4):

The TxSAR will place this value into the vpi field of the cell header.

vci (bits 3:0):

The TxSAR will place this value into the vci field of the cell header.

Field 2

vci (bits 15:4):

The TxSAR will place this value into the vci field of the cell header.

pti (bits 3:1):

The TxSAR will place this value into the pti field of the cell header.

clp (bit 0):

The TxSAR will place this value into the clp field of the cell header.

Field 3

hec (bits 15:8):

The physical layer is generally responsible for calculating the hec value and therefore this field is normally used as a place holder. If the physical layer does not calculate hec then the contents of the hec field of the TxSAR control structure will appear in the hec field of the cell header. The user may generate this value by preforming a modulo 2 division on the first 4 octets of the cell header using the generator polynomial G(x)=x 8+xˆ 2+x+1.

udf (bits 7:0):

This value is copied to the udf2 field of the cell header when the UTOPIA module is operating in 16 bit mode.

Field 4

Field 4 contains the number of cells that have been transmitted. The cpu should initialize this field to 0000h.

Control Structure Pointer Table

In the SDT DBCES and Non DBCES modes the TxSAR makes use of pointer tables to determine the location of each control structure in the internal memory 3. Each port of the device which is in SDT mode has a pointer table associated with it. The base address of the pointer table, in internal memory, is programmed through the PX_PTB register shown in the table below.

Port 0 Pointer Table Base Address
Address: 2002 (Hex)
Label: P0_PTB
Reset Value: 0000 (Hex)

| | Bit | | |
|---|---|---|---|
| Label | Position | Type | Description |
| PTBA | 15:0 | R/W | In SDT mode these bits hold the base address |
| | | | of the port 0 control structure pointer table. |
| | | | In UDT mode these bits form a pointer to the |
| | | | UDT control structure associated with port 0. |

As shown in FIG. 5, the PX_PTB register contains the word address of the pointer table X base in internal memory. For example a value of 10h indicates that the base of the pointer table starts on the 16th word in internal memory (byte address 20h). The value in the PX_PTB represents an offset from the base address of the TxSAR internal memory in the Monaco chip.

The following is a description of the fields of a pointer:

L (Bit 15):

A value of 1 in this bit indicates that the current pointer is the last valid pointer in the table and as a result the TxSAR will not read any further entries in the current table.

A (Bit 14):

A value of 1 in this bit indicates that the associated control structure is active. If this bit is set to 0 the TxSAR will not produce cells for the associated control structure.

Control Structure Pointer (Bits 13:0):

This is the address of a control structure expressed as a word offset from the base address of the TxSAR Internal memory.

A detailed description of each field of the TxSAR control structure for non DBCES SDT mode follows with reference to FIG. 6.

Field 0

nmbr_of_tdm(15:10):

This field indicates the number of TDM octets required to fill the next cell of the corresponding VCC. It is used by the TxSAR to determine when to create a cell for the VCC associated with the control structure. After each cell of the VCC is sent the TxSAR will determine the number of octets available for TDM in the next cell and update the nmbr_of_tdm field. This field must be initialized by the user as shown in the Table below.

| TDM | | |
|---|---|---|
| mode | nmbr_of_channels | nmbr_of_tdm value |
| DS1 | 1 | 45 |
| DS1 | 2:24 | 46 |
| E1 | 1 | 44 |
| E1 | 2 | 45 |
| E1 | 3:30 | 46 |
| J2 | 1:96 | 46 |
| STBUS | 1:30 | 46 |

nmbr_of channels (9:2):

The nmbr_of_channels (Number of Channels) bits indicate the number of TDM channels in the VCC associated with the control structure. The following table summarizes the range of possible values.

| | Range of values in |
|---|---|
| TDM Type | nmbr_of_channels field |
| DS1 | 1 to 24 |
| E1 | 1 to 30 |
| Back Plane Mode | 1 to 128 |

remainder (bit 1):

This bit indicates that there is enough TDM data to create more than 1 cell in the current frame. It should be initialized to 0.

wait for multiframe (bit 0):

When 1 the TxSAR will wait for the multiframe boundary before producing the first cell of the VCC. This will result in the first basic frame of the multiframe being sent in the first payload octet of the first cell (sequence=0, offset field=0). When 0 the first cell will be produced as soon as enough TDM data is available.

Field 1

read pointer (bits 15:10):

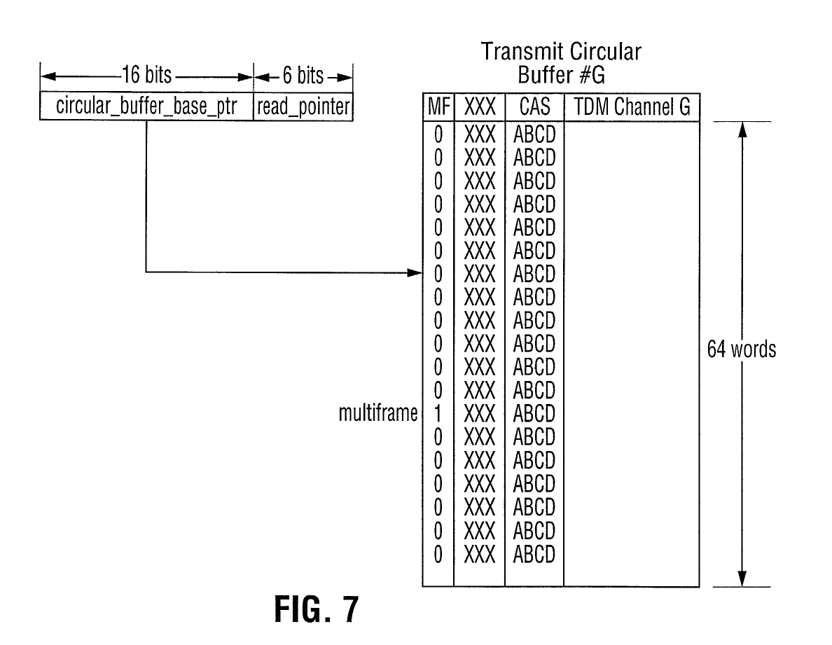

The value in this field is concatenated with circular_buffer_base_ptrG to form an address within a circular bufferG as shown in FIG. 7. The read_pointer field will be incremented each time current_tdm=last_tdm. Initialize this field to 00h unused (bits 9:8):

Reserved for future use. Initialize these bits to 0.

first_cell (bit 7)

This bit should be initialized to 1 by the cpu It is used to indicate that this is the first cell to be sent for the current VCC.

srts (bits 6:3):

If the srts_enable (se) bit of the current VCC is set to one then the TxSAR will read an SRTS nibble from the Clock Management block at the beginning of each cell sequence (sequence =b#000). This value will be stored in the srts bits. In cells with odd sequence numbers the most significant bit of the SRTS value will be placed into the csi bit of the SAR-PDU header. The SRTS value will then be shifted left and written back. In this way a complete SRTS nibble will be sent in each 8 cell sequence. This field does not need to be initialized by the user.

sequence (bits 2:0):

The sequence bits hold the sequence number of the cell that is about to be assembled by the TxSAR. This value is used by the TxSAR to generate the SAR-PDU header and determine if the current cell is to be a P format cell. The sequence number of the next cell in the VCC is determined using the equation:

$$NextSequence ( CurrentSequence ) = \vert \begin{matrix}CurrentSequence + 1 forCurrentSequence < 7 \\ 0 forCurrentSequence = 7\end{matrix}$$

The next sequence number is written to the sequence bits of the TxSAR control structure after the current cell has been sent.

Initialize sequence to 0h.

Field 2

structure_lngth(bits 15:4):

The structure_lngth (Structure Length) field contains the length of the multiframe structure (payload substructure+signalling substructure). As an example:

TDM type=DS1

nmbr_of_channels=3

structure_lngth=nmbr_of_channels×24+roundup(nmbr_of_channels/2)=74 octets

The following table provides a summary of possible values.

Value in the Structure Length field (nmbr_of_channels=#of channels in the VCC)

| | Value to be written to | Range of Structure |
|---|---|---|
| TDM Type | Structure Length field | Length value |
| DS1 with CAS | 24 × nmbr_of_channels + | 25 to 3136 |
| | roundup(nmbr_of_channels/2) | |
| E1 with CAS | 16 × nmbr_of_channels + | 17 to 2112 |
| | roundup(nmbr_of_channels/2) | |
| DS1 without CAS | nmbr_of_channels | 1 to 128 |
| E1 without CAS | nmbr_of_channels | 1 to 128 |

unused (bits 3:2)

Reserverd for future use. Initialize these bits to 0.

mode (bits 1:0)

The TxSAR requires the mode bits to determine the number of TDM octets in a cell pay-load. They are used to indicate the TDM structure size relative to a cell payload and the TDM type being used. The meaning of the bits is given in the following table.

Description of mode bits

| Value of mode bits | Meaning |
|---|---|
| 00 | CCS mode or DS1 with CAS number of channels > |
| | 1 or E1 with CAS number of channels > 2. |
| 01 | DS1 with CAS number of channels = 1 |
| 10 | E1 with CAS number of channels = 1 |
| 11 | E1 with CAS number of channels = 2 |

Field 3

structure_boundary_ptr (bits 15:4):

The structure_boundary_ptr (Structure Boundary Pointer) bits contain the distance, in ocets, between the last payload byte written and the next structure boundary. The TxSAR uses this value to keep track of its current position in the multiframe structure, determine when to send a P format cell and to generate the offset field of the SAR-PDU header. Initialize the structure_boundary_ptr field to h#0000.

srst_enable (bit 3):

The srts_enable (se) bit is used to indicate that the associated VCC is carrying SRTS data. When high the TxSAR will place SRTS data into the csi bit of the SAR-PDU header in cells with odd sequence values. When low the csi bit will be set to zero in cells with odd sequence values. Only one VCC/per link may carry SRTS.

pointer_sent (bit 2):

The pointer_sent (ps) bit is used to ensure that only a single P format cell is sent within an eight cell sequence. When the P format cell occurs this bit will be set high by the TxSAR. No further P format cells will be produced while ps=1. When the last cell of the sequence (sequence=b#111) is sent ps will be cleared so that another P format cell will be produced in the next cell sequence. The pointer_sent bit should be initialized to the value of the pointer_enable bit.

pointer enable (bit 1):

The pointer_enable (pe) bit should be set to zero in a single channel VCC which is not transporting CAS. This will prevent P format cells from being produced for the VCC. pe should be set to one in all other cases. This will cause the P format cell to be generated once per eight cell sequence.

pointer_cell (bit 0)

After transmission of a cell the TxSAR will determine if the next cell of the VCC is to be a P format cell and will set the pointer cell (p) bit accordingly. When the time comes to create the next cell the SAR will place the SAR-PDU pointer field in the cell if p=1. This bit must be initialized to the value in the pointer_enable field.

Field 4

current_cas (bits 15:8):

When the TxSAR is writing CAS data to the cell payload it will use this field to keep track of which circular buffer pointer to read next. Initialize this field to 0Ah.

current_tdm (bits 7:0):

When the TxSAR is writing TDM data to the cell payload it will use this field to keep track of which circular buffer pointer to read next. Initialize this field to 0Ah.

Field 5

last (bits 15:8):

This field contains the address (relative to field 0) of the last valid circular_buffer_base_ptr in the control structure. In general

last=nmbr_of_channels+9

### EXAMPLE

nmbr_of_channels=8

last=11 h

nmbr_of_cas (bits 7:0):

The nmbr_of_cas (ncas) field contains the size, in octets, of the signalling substructure and should be initialized as shown in Table

### EXAMPLE

In the case of a DS 1 link with nine channels in the payload substructure. nmbr_of_cas=5.

Possible nmbr_of_cas values. K=# of channels in the structure

| TDM mode | Formula | nmbr_of_cas Range |
|---|---|---|
| DS1 | roundup(K/2) | 0 to 64 |
| E1 | roundup(K/2) | 0 to 64 |
| CCS mode | NA | 0 |

Field 6

cell_count_statistic (bits 15:0):

The cell_count_statistic bits indicate the number of cell that have been produced for the VCC. Initialize these bits to 0000h.

Header 1

gfc (bits 15:12):

The gfc (Generic Flow Control) value is placed in the gfc field of the cell header in a UNI cell. If the associated cell is NNI these bits form the four most significant bits of the vpi. vpi (bits 11:4):

The TxSAR will place this value into the vpi field of the cell header.

vci (bits 3:0):

The TxSAR will place this value into the vci field of the cell header.

1.0.16 Header 2

vci (bits 15:4):

The TxSAR will place this value into the vci field of the cell header.

pti (bits 3:1):

The TxSAR will place this value into the pti field of the cell header.

clp (bit 0):

The TxSAR will place this value into the clp field of the cell header.

Header 3

hec (bits 15:8):

The physical layer is generally responsible for calculating the hec value and therefore this field is normally used as a place holder. If the physical layer does not calculate hec then the contents of the hec field of the TxSAR control structure will appear in the hec field of the cell header. The user may generate this value by preforming a modulo 2 division on the first 4 octets of the cell header using the generator polynomial G(x)=x 8+xˆ 2+x+1.

udf (bits 7:0):

This field is copied to the udf2 field of the cell header when the UTOPIA module is operating in 16 bit mode.

Circular Buffer Pointer Space circular_buffer_base_ptrX (bits 15:0):

The Circular Buffer base pointers are concatenated with the read pointer bits to form the 22 bit address shown in FIG. 7. This value is used to address a TDM or CAS value in a particular circular buffer. There will be a pointer for each channel in the VCC.

DBCES Control Structure

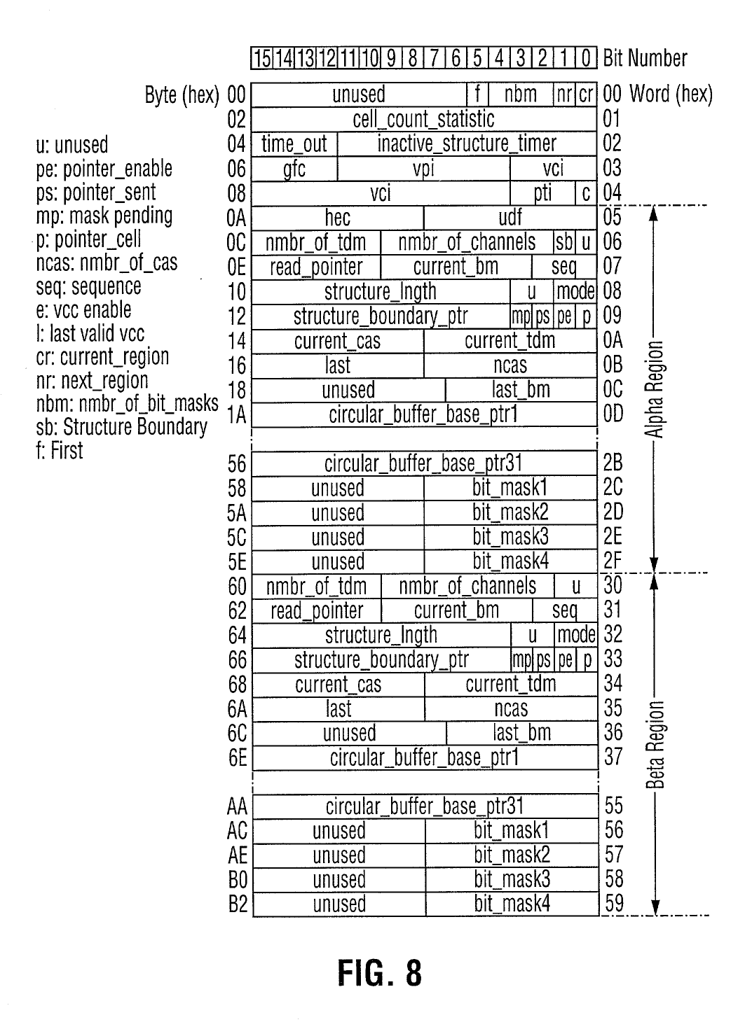

The DBCES Control Structure is shown in FIG. 8.

Field 0

unused(Bits 15:6):

These bits are reserved for future use and should be initialized to 0.

first(Bit 5)

This bit shoud be set to 1 by the cpu when the control structure is initialized.

number_of_bit_masks (Bits 4:2)

The following table indicates the number of masking octets in the bit mask substructure.

meaning of nmbr_of_bit_mask bits

| nmbr_of_bit_mask bits | Size of bit masking substructure |
|---|---|
| 001 | 1 octet |
| 010 | 2 octets |
| 011 | 3 octets |
| 100 | 4 octets |
| all others | Invalid |

next_region (Bit 1):

This bit is used to re-size the multiframe structure and indicates the region of the control structure which will be used after the re-size occurs. When the time comes to re-size the structure the cpu should initialize the region of the control structure which is not being read by the TxSAR. The next region bit is then set cpu must wait for the next_region and current_region bits to contain the same value. It may then set the next_region bit

next_region bit definition

| next_region | control structure region used after re-size |
|---|---|
| 0 | Alpha region |
| 1 | Beta region |

current_region (Bit 0):

This bit indicates the region of the control structure that the TxSAR is currently using to construct cells refer to the following table. To re-size the structure the cpu should write in the region which is not being used to assemble cells. Initialize this bit to 0.

current_region bit definition

| | control structure region | region available for the |
|---|---|---|
| current_region | currently being used | cpu to write |
| 0 | Alpha region | Beta region |
| 1 | Beta region | Alpha region |

Field 1 cell_count_statistic

This field contains the number of cells which have been currently sent. It should be initialized to 0000h.

Field 2

time_out (Bits 15:12):

These bits are used to control the time between the transmission of cells which are transporting inactive structures. The time between cells is determined as follows:

inactive_structure_timer (11:0):

These bits are used to determine if it is time to send a cell which is carrying an inactive structure. The cpu should initialize this value to 000 h.

Cell Header Fields

These fields are placed into the cell header

Field 6 Alpha and Beta regions

nmbr_of_tdm (Bits 15:10):

This value is represents the number of octets in the next cell which are available fro transporting TDM. Initialize this value according to the following table.

Initialization of nmbr_of_tdm bits

| multi frame configuration | nmbr_of_tdm |
|---|---|
| DS1 with CAS nmbr_of_channels = 1 | 45 |
| E1 with CAS nmbr_of_channels = 1 | 44 |
| E1 with CAS nmbr_of_channels = 2 | 45 |
| all other configurations | 46 |

nmbr_of_channels (Bits 9:2):

The nmbr_of_channels value indicates the number of TDM channels in the VCC associated with the control structure and may contain a value of 0 to 31 inclusive.

structure_boundary_in_next_cell (Bit 1):

This bit indicates that the structure boundary will occur in the next cell. Initialize this value to 1.

unused (Bit 0):

This bit is reserved for future use and should be initialized to 0.

Field 7 Alpha and Beta Regions

read_pointer (Bits 15:10):

This value is concatenated with the circular buffer pointer to form an address to a TDM/CAS value in a circular buffer. In the case of many N=1 VCCs these bits may be used to distribute cell production over 64 frames.

current_bit_mask (Bits 9:3):

This is a pointer to the next bit mask to be sent. Initialize this value according the following table.

Initialization of current_bit_mask

| Control Structure Region | current_bit_mask initialization value |
|---|---|
| Alpha | 2Ch |
| Beta | 56h |

sequence (Bits 2:0):

These bits hold the sequence number of the next cell. Initialize this value to 0h.

Field 8 Alpha and Beta Regions

structure_length (Bits 15:3):

This value represents the length of the multiframe structure and should be initialized as follows:

Initialization of structure_length value

| | Value to be written to Structure | Range of Structure |
|---|---|---|
| TDM Type | Length field | Length value |
| DS1 with CAS | 24 × nmbr_of_channels + | 0 to 588 |
| | roundup(nmbr_of_channels/2) | |
| E1 with CAS | 16 x nmbr_of_channels + | 0 to 495 |
| | roundup(nmbr_of_channels/2) | |
| DS1 without CAS | nmbr_of_channels | 0 to 31 |
| E1 without CAS | nmbr_of_channels | 0 to 31 |

unused (Bits 3:2):

Reserved for future use. Initialize these bits to 0h.

mode (Bits 1:0):

Initialize these bits according to the following table.

Initialization of mode bits

| Configuration | mode |
|---|---|
| DS1 with CAS nmbr_of_channels = | 01b |
| 1 | |
| E1 with CAS nmbr_of channels = | 10b |
| 1 | |
| E1 with CAS nmbr_of_channels = | 11b |
| 2 | |
| all other conditions | 00b |

Field 9 Alpha and Beta regions structure_boundary_pointer (Bits 15:4):

This pointer is used to keep track of the current location with in the multi-frame structure. Initialize this value to 000h.

mask_pending (Bit 3):

This bit indicates that a bit mask will occur within the next 94 octets. Initialize this bit to 1.

pointer_sent (Bit 2):

Indicates that a pointer was sent in the current cell sequence. Initialize this bit to 0.

pointer_enable (Bit 1):

Initialize this bit to 1.

pointer_cell (Bit 0):

This bit indicates that the next cell is a pointer cell. Initialize this bit to 1.

Field 10 Alpha and Beta regions

current_cas (Bits 15:8):

This is a pointer to the next circular buffer from which CAS is to be read. Initialize this value according to the following table.

Initialization of current_cas pointer

| Control Structure Region | current_bit_mask initialization value |
|---|---|
| Alpha | 0Dh |
| Beta | 37h |

current_tdm (Bits 7:0):

This is a pointer to the next circular buffer from which TDM is to be read. Initialize this value according Table

Initialization of current_tdm pointer

| Control Structure Region | current_bit_mask initialization value |
|---|---|
| Alpha | 0Dh |
| Beta | 37h |

Field 11 Alpha and Beta region

last (Bits 15:8):

This is a pointer to the last circular buffer pointer in the control structure. Initialize this pointer according to the following table.

Initialization of last pointer

| Control Structure Region | current_bit_mask initialization value |
|---|---|
| Alpha | nmbr_of_channels + 0Ah |
| Beta | nmbr_of_channels + 36h |

nmbr_of_cas (Bits 7:0):

This value represents the number of CAS octets in the multiframe structure. Initialize this value as shown in the following table.

Initialization of the nmbr_of_cas value

| Configuration | nmbr_of_cas value |
|---|---|
| CAS mode | roundup(nmbr_of_channels/2) |
| CCS mode | 0 |

Field 12 Alpha and Beta regions

unused (Bits 15:7):

Reserved for future revisions. Initialize to 000h.

last_bit_mask (6 bits):

This is a pointer to the last bit mask in the control structure. Initialize this pointer according to the following table.

Initialization of last bit mask pointer

| Control Structure Region | current_bit_mask initialization value |
|---|---|
| Alpha | number of bit masks + 2Bh |
| Beta | number of bit masks + 55h |

Circular buffer pointer space

circular_buffer_base_ptrX (bits 15:0):

The Circular Buffer base pointers are concatenated with the read_pointer bits to form the 22 bit address shown in FIG. 7. This value is used to address a TDM or CAS value in a particular circular buffer. There will be a pointer for each channel in the VCC.

Bit mask space

These values are placed into the bit masking octets of the cell. The contents of the field are set to conform with AF-VTOA-0085.000 July 1997. The values are written to the cell in order starting with field 44.

The TXSAR registers will now be listed.

Port 0TxSAR Operation Mode Register

Address: 2000 (Hex)
Label: P0_TXOM
Reset Value: 0000 (Hex)

| | Bit | | |
|---|---|---|---|
| Label | Position | Type | Description |
| TCFNG | 1:0 | R/W | TxSAR Configuration. |
| | | | 00 TxSAR is disabled |
| | | | 01 UDT mode |
| | | | 10 SDT DBCES Mode |
| | | | 11 SDT Non DBCES Mode |
| Reserved | 15:2 | R/O | Reserved. Always read |
| | | | “0000_0000_0000_00”. |

Data TX_SAR Configuration Register

Address: 2004 (Hex)
Label: TXCFGR
Reset Value: 0000 (Hex)

| | Bit | | |
|---|---|---|---|
| Label | Position | Type | Description |
| DTSIZE | 1:0 | R/W | Data TX_SAR cell buffer size selection. |
| | | | 00-16 Cells |
| | | | 01-32 Cells |
| | | | 10-64 Cells |
| | | | 11-128 Cells |
| DTBASE | 10:2 | R/W | Data TX_SAR Cell Buffer Base Address. These bits |
| | | | represent address bits 20:12 of the base address of |
| | | | the cell buffer in external memory. |
| Reserved | 15:11 | R/O | Always read “0000_0” |

Data TX_SAR Write Pointer

Address: 2006 (Hex)
Label: DTWPR
Reset Value: 0000 (Hex)

| | Bit | | |
|---|---|---|---|
| Label | Position | Type | Description |
| DTWP | 7:0 | R/W | Data TX_SAR Write Pointer. |
| | | | Indicates the cell structure number in which |
| | | | the cpu is currently writing (the cell |
| | | | is not yet valid). |
| Reserved | 15:8 | R/O | Always read “0000_0000” |

Data TX_SAR Read Pointer

Address: 2008 (Hex)
Label: DTRPR
Reset Value: 0000 (Hex)

| | Bit | | |
|---|---|---|---|
| Label | Position | Type | Description |
| DTWP | 6:0 | R/O | Data TX_SAR Read Pointer. |
| | | | Indicates the cell structure number in which |
| | | | the Data TX_SAR is currently reading. |
| | | | This pointer is cleared when the TDSEN bit |
| | | | in the Data TX_SAR control register is |
| | | | set to 0. |
| Reserved | 15:7 | R/O | Always read “0000_0000_0” |

Data TX_SAR Control Register

Address: 200A (Hex)
Label: DTCR
Reset Value: 0000 (Hex)

| | Bit | | |
|---|---|---|---|
| Label | Position | Type | Description |
| TDSEN | 0 | R/W | Data TX_SAR Enable. When 0 |
| | | | the read pointer is reset to 0000_000 and no |
| | | | data cells are produced. When 1 the Data |
| | | | TX_SAR will send the cells in the |
| | | | cell buffer. |
| AUTO | 1 | R/W | When 1 the Data TX_SAR will produce |
| | | | cells when the CBR TX_SAR is not busy. |
| | | | When 0 the Data cell generation is controlled |
| | | | by the DCGTOR register. |
| FMTIE | 2 | R/W | Cell Buffer Empty Interrupt Enable. |
| | | | When 1 the Cell Buffer Empty interrupt will |
| | | | be asserted when the cell buffer is empty. |
| | | | When 0 this interrupt is masked. |
| Reserved | 15:3 | R/O | Always read “0000_0000_0000_0” |

TABLE 2
Data Cell Generation Time Out Register

Address: 200C (Hex)
Label: DCGTOR
Reset Value: 0001 (Hex)

| | Bit | | |
|---|---|---|---|
| Label | Position | Type | Description |
| DCGP | 9:0 | R/W | These bits represent the time in mS between |
| | | | data cell transmission when the Data |
| | | | TX_SAR is in timer mode. A value of |
| | | | 0000_0000_00 will disable data |
| | | | cell transmission. |
| Reserved | 15:10 | R/O | Always read “0000_00” |

Data TX_SAR Status Register

Address: 200E (Hex)
Label: DTSR
Reset Value: 0000 (Hex)

| | Bit | | |
|---|---|---|---|
| Label | Position | Type | Description |
| TBMT | 0 | R/O | Transmit Cell Buffer Empty. This bit |
| | | | is set when the read pointer is equal to the |
| | | | write pointer and indicates that all of |
| | | | the cells in the buffer have been sent. |
| Reserved | 15:1 | R/O | Always read “0000_0000_0000_000” |

The use of the template data structure described considerably improves the efficiency of cell formation in a SAR device in ATM services.

1. A method of assembling cells for use in a cell relay network, comprising the steps of creating a template data structure representing the structure of a cell to be assembled, storing said template data structure in memory, and creating cells by retrieving said template data structures and inserting variable information therein.

2. A method as claimed in claim 1, wherein a pointer table stores the location of said data structures in memory.

3. A method as claimed in claim 2, wherein a separate pointer is provided for each virtual channel in the network.

4. A method as claimed in claim 1, wherein circular pointers control which circular buffers are associated with a virtual channel in said network.

5. A method as claimed in claim 4, wherein the circular buffer pointers to control the order in which data is placed in the cell payload.

6. A method as claimed in claim 1, wherein said template data structure is created by a program running on a central processing unit.

6. A method as claimed in claim 1, wherein in a DBCES service with a multiframe structure, re-sizing of the multiframe structure is carried out with the aid of a DBCES cell template.

7. A method as claimed in claim 6, for use in an SDT DBCES (Structured Data Transfer Dynamic Bandwidth Circuit Emulation) service, wherein the DBCES data structure has three major regions, namely a first region containing information that does not change when the multiframe structure is re-sized, and two regions containing information that changes during multiframe resize.

8. A method as claimed in claim 1, wherein said cells are Unstructured Data Transfer (UDT), Structured Data transfer (SDT), or DSS (Dynamic Structure sizing) cells.

9. A device for assembling cells from a data stream for transmission over a cell relay network, comprising:
a memory storing a template data structure representing the structure of a cell to be assembled; and
a segmentation unit for retrieving said template data structure from said memory and creating cells by inserting variable information therein.

10. A device as claimed in claim 9, wherein said memory is connected to a microprocessor controlling the operation thereof.

11. A device as claimed in claim 9, further comprising a pointer table storing the location of said data structures in said memory.

12. A device as claimed in claim 9, further comprising circular buffers associated with virtual channels in said network, and circular pointers for controlling which circular buffers are associated with which channels.

13. A device as claimed in claim 9, wherein the circular buffer pointers control the order in which data is placed in the cell payload.

14. A device as claimed in any claim 9, further comprising a central processing unit connected to said memory and controlling the operation thereof. cm 15. The use of cell template data structures to form ATM cells.
